(19) United States
(12) Patent Application Publication
(10) Pub. No.: US 2015/0124678 A1
(43) Pub. Date: May 7, 2015

(54) SYSTEM AND METHOD FOR ACCESS POINT POWER MANAGEMENT SIGNALLING IN A WIRELESS NETWORK

(71) Applicant: QUALCOMM Incorporated, San Diego, CA (US)

(72) Inventors: Alfred Asterjadhi, San Diego, CA (US); Amin Jafarian, San Diego, CA (US)

(21) Appl. No.: 14/532,827

(22) Filed: Nov. 4, 2014

Related U.S. Application Data
(60) Provisional application No. 62/035,930, filed on Aug. 11, 2014.
(60) Provisional application No. 61/901,350, filed on Nov. 7, 2013.

(51) Int. Cl. H04W 52/02

(52) U.S. Cl. CPC H04W 52/0206
USPC 370/311

(57) ABSTRACT

Systems and methods for wireless communication are disclosed. In one aspect an access point includes a processor configured to generate a message which contains a frame control field containing an indication that the access point will ignore reception of packets from one or more wireless stations for a period of time. The access point also includes a transmitter, which is configured to transmit the message to one or more wireless stations associated with the access point.

### CLAIM OF PRIORITY UNDER 35 U.S.C. §119

The present application for patent claims priority to Provisional Application No. 62/035,930 entitled “SYSTEM AND METHOD FOR ACCESS POINT POWER MANAGEMENT SIGNALLING IN A WIRELESS NETWORK” filed Aug. 11, 2014, and assigned to the assignee hereof and hereby expressly incorporated by reference herein. The present application for patent further claims priority to Provisional Application No. 61/901,350 entitled “SYSTEM AND METHOD FOR ACCESS POINT POWER MANAGEMENT SIGNALLING IN A WIRELESS NETWORK” filed Nov. 7, 2013, and assigned to the assignee hereof and hereby expressly incorporated by reference herein.

### BACKGROUND

1. Field

The present application relates generally to wireless communications, and more specifically to systems, methods, and devices for access point power management signaling in a wireless network.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. The packets may include overhead information (e.g., header information, packet properties, etc.) that helps in routing the packet through the network, identifying the data in the packet, processing the packet, etc., as well as data, for example user data, multimedia content, etc. as might be carried in a payload of the packet.

### SUMMARY

Various implementations of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various implementations allow sleep time for an access point.

One aspect of the present disclosure provides an access point on a wireless network including a processor configured to generate a message, the message containing a frame control field which contains an indication that the access point will ignore reception of packets from one or more wireless stations for a period of time and a transmitter connected to the processor and configured to transmit the message to one or more wireless stations associated with the access point. The indication may include a one-bit data field. The indication may include a reserved data field or a data field with a reserved value, or an access point (AP) power management (PM) data field. The data field with a reserved value may include a power management data field. The indication may further indicate the presence of an access point power management element. The message may include a management frame or an extended frame. The management frame or extended frame may include one of a beacon, a short beacon, an action frame, or a resource allocation frame. In some aspects, the beacon may include a S1G beacon frame. The message may further include an indication of the amount of time that the wireless device will ignore reception of packets from one or more wireless stations. The message may signal that the access point will ignore reception of packets from one or more wireless stations which are a subset of the one or more wireless stations associated with the access point. The message may further contain an indication that the access point will be awake for a particular portion of a beacon interval. The particular portion of the beacon interval or the short beacon interval may immediately follow a transmission of the message. The particular portion of the beacon interval or the short beacon interval may be pre-defined or be based on a deterministic function. The transmitter may be further configured to transmit a second message which indicates a maximum duration that the access point may ignore reception of packets from one or more wireless stations.

One aspect of the present disclosure provides a method of wireless communication, including generating a message on an access point, the message containing a frame control field which contains an indication that the access point will ignore reception of packets from one or more wireless stations for a period of time, and transmitting the message to one or more wireless stations associated with the access point.

In one aspect, the present disclosure provides an access point on a wireless network, the device including means for generating a message on the access point, the message containing a frame control field which contains an indication that the access point will ignore reception of packets from one or more wireless stations for a period of time, and means for transmitting the message to one or more wireless stations associated with the access point.

One aspect of the present disclosure provides a non-transitory computer readable storage medium comprising computer executable instructions configured to implement a method for wireless communication, the method including generating a message on an access point, the message containing a frame control field which contains an indication that the access point will ignore reception of packets from one or more wireless stations for a period of time, and transmitting the message to one or more wireless stations associated with the access point.

In one aspect, the disclosure provides a method for wireless communication, the method including receiving, at a wireless device, a message from an access point, the message containing a frame control field which contains an indication that the access point will ignore reception of packets from the wireless device during at least a portion of a beacon interval, and deferring transmissions to the access point during at least a portion of the beacon interval. The method may also include receiving, at a wireless device, a second message including a maximum duration during which the access point may ignore reception of packets from the wireless device, and determining, based at least on the maximum duration and on the indication, the portion of the beacon interval that the access point will ignore reception of packets. The portion of the beacon interval that the access point will ignore reception of packets may be a last portion of the beacon interval. The method mat further include transmitting a packet to the access point during a first portion of the beacon interval prior to the last portion of the beacon interval. The indication may include a one-bit data field. The message may include a management frame or an extended frame, which may include one of a beacon, a short beacon, an action frame, or a resource allocation frame.

In one aspect, the disclosure provides a device for wireless communication, the device including a receiver configured to receive a message from an access point, the message containing a frame control field which contains an indication that the access point will ignore reception of packets from the device during at least a portion of a beacon interval, and a processor configured to defer transmissions to the access point during at least a portion of the beacon interval.

One aspect of the present disclosure provides a device for wireless communication, the device including means for receiving, at a wireless device, a message from an access point, the message containing a frame control field which contains an indication that the access point will ignore reception of packets from the wireless device during at least a portion of a beacon interval, and means for deferring transmissions to the access point during at least a portion of the beacon interval.

In one aspect, the present disclosure provides a non-transitory computer readable storage medium comprising computer executable instructions configured to implement a method for wireless communication, the method including receiving, at a wireless device, a message from an access point, the message containing a frame control field which contains an indication that the access point will ignore reception of packets from the wireless device during at least a portion of a beacon interval, and deferring transmissions to the access point during at least a portion of the beacon interval.

### BRIEF DESCRIPTION OF THE DRAWINGS

FIG. 1 illustrates an example of a wireless communication system in which aspects of the present disclosure may be employed.

FIG. 2 illustrates an example of a wireless device that may be employed within the wireless communication system of FIG. 1.

FIG. 3 illustrates an example of components that may be included within the wireless device of FIG. 2 to transmit wireless communications.

FIG. 4A illustrates an example of components that may be included within the wireless device of FIG. 2 to transmit wireless communications.

FIG. 4B illustrates an exemplary series of messages and communications between an access point and a station, according to certain aspects of the present disclosure.

FIG. 5 is an exemplary Access Point Power Management element which may be transmitted to wireless stations associated with the access point to indicate that the Access Point will enter a sleep state.

FIG. 6 is an illustration of a Frame Control field of a Management frame.

FIG. 7 is a short beacon (sub 1 GHz Beacon) frame which may be modified to signal whether an Access Point will enter a sleep state.

FIG. 8 illustrates a resource allocation frame which may be modified to signal whether an Access Point will enter a sleep state.

FIG. 9 is a flowchart of a method of wireless communication in accordance with one implementation.

FIG. 10 is a flowchart of a method of wireless communication in accordance with one implementation.

FIG. 11 is an illustration of the timing of a maximum away duration in a beacon interval.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which includes the use of sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, commonly known as “STAs”). In general, an AP serves as a hub or base station for the WLAN and a STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations, an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology. The access point may be a main or relay base station. A relay base station relays data between wireless stations and another base station, being the main base station or another relay base station.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

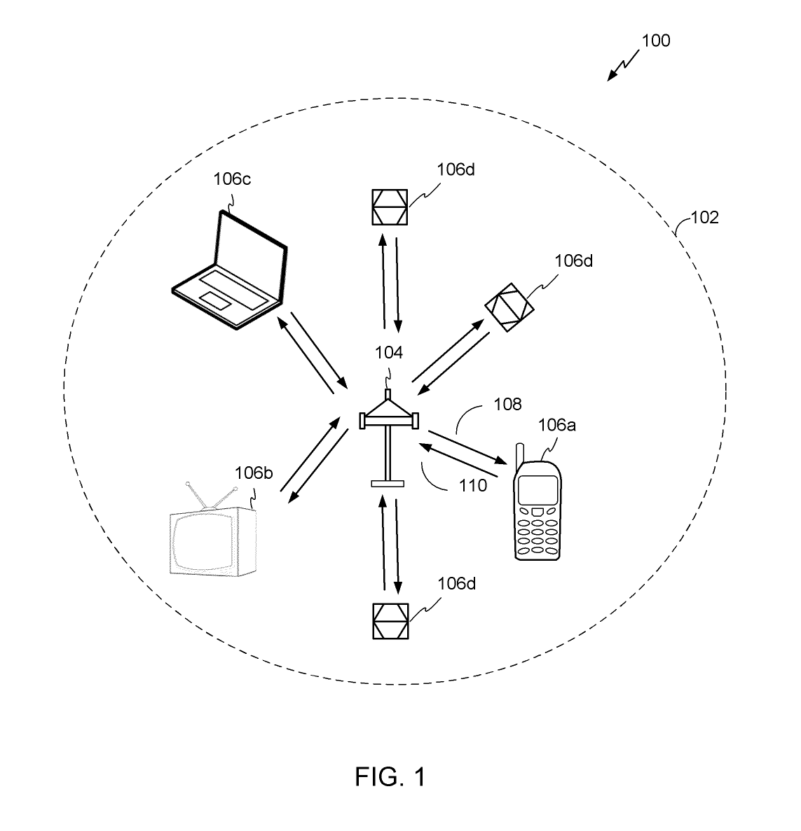

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The STAs 106 are not limited in type and may include a variety of different STAs. For example, as illustrated in FIG. 1, STAs 106 can include a cellular phone 106a, a television 106b, a laptop 106c, and a number of sensors 106d (e.g. a weather sensor or other sensor capable of communicating using a wireless protocol), to name a few.

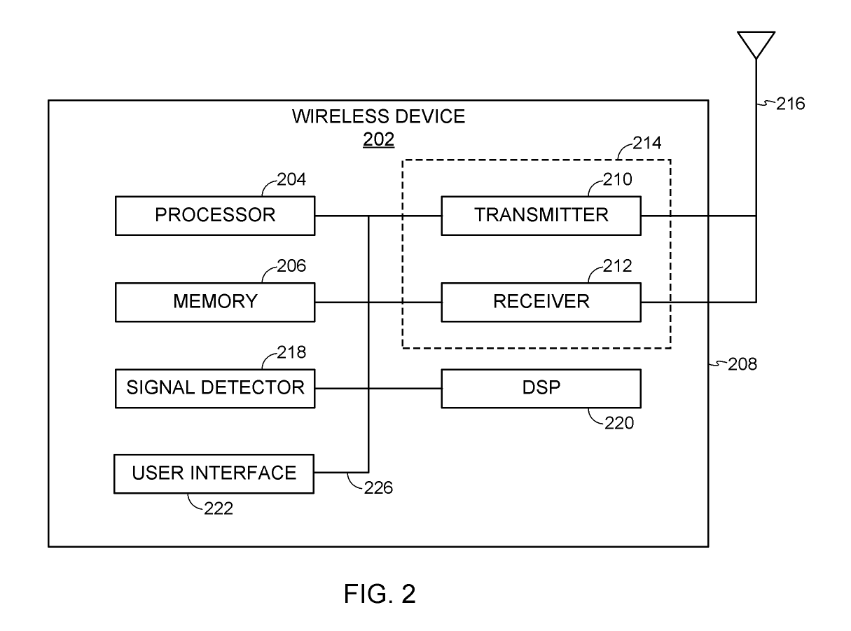

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a transmitter 210 and a receiver 212 to allow transmission and reception of data between the wireless device 202 and a remote location. Further, the transmitters 210 and the receiver 212 may be configured to allow transmission and reception of setup and/or configuration packets or frames between the wireless device 202 and a remote location including, for example, an AP. The transmitter 210 and receiver 212 may be combined into a transceiver 214. An antenna 216 may be attached to the housing 208 and electrically coupled to the transceiver 214. Alternatively, or additionally, the wireless device 202 may include an antenna 216 formed as part of the housing 208 or may be an internal antenna. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet or a frame.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be housed within a housing 208. Further, the various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together, or may accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

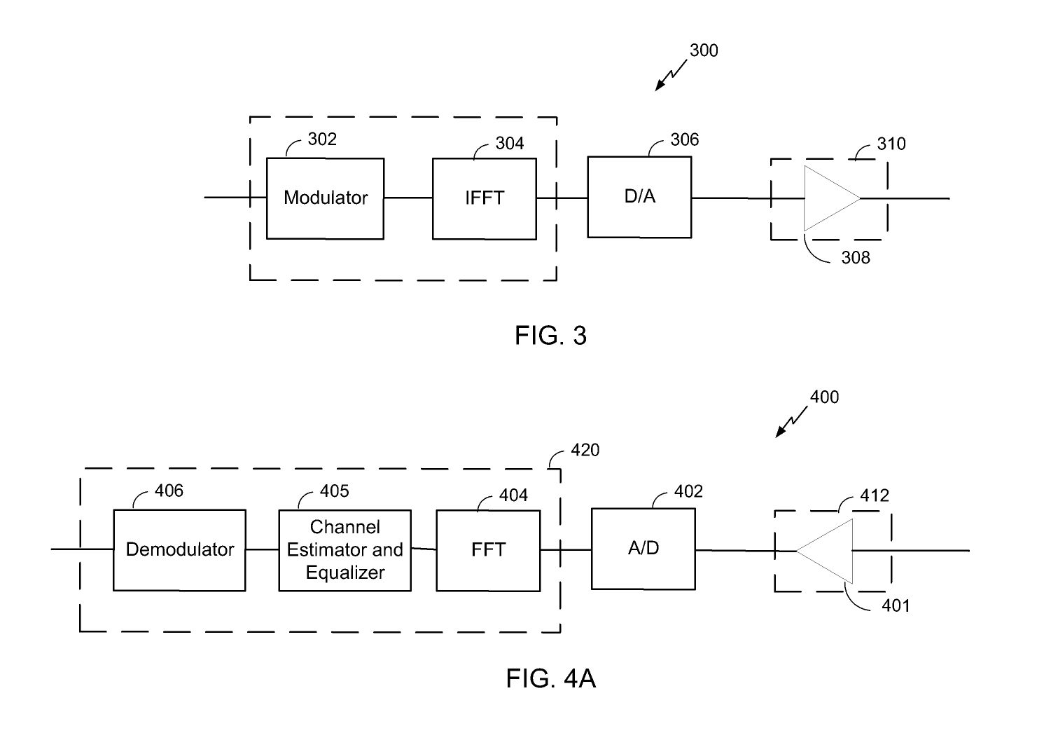

As discussed above, the wireless device 202 may comprise an AP 104 or an STA 106, and may be used to transmit and/or receive communications. FIG. 3 illustrates a transmitter module 300 that may be utilized in the wireless device 202 to transmit wireless communications. The components illustrated in FIG. 3 may be used, for example, to transmit OFDM communications.

The transmitter module 300 may comprise a modulator 302 configured to modulate bits for transmission. For example, if the transmitter module 300 is used as a component of wireless device 202 in FIG. 2, the modulator 302 may determine a plurality of symbols from bits received from the processor 204 or the user interface 222, for example by mapping bits to a plurality of symbols according to a constellation. The bits may correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The transmitter module 300 may further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there may be multiple transform modules (not shown) that transform units of data of different sizes.

In FIG. 3, the modulator 302 and the transform module 304 are illustrated as being implemented in the DSP 320. In some aspects, however, one or both of the modulator 302 and the transform module 304 may be implemented in other components of wireless device 202, such as in the processor 204.

Generally, the DSP 320 may be configured to generate a data unit for transmission. In some aspects, the modulator 302 and the transform module 304 may be configured to generate a data unit comprising a plurality of fields including control information and a plurality of data symbols. The fields including the control information may comprise one or more training fields, for example, and one or more signal (SIG) fields. Each of the training fields may include a known sequence of bits or symbols. Each of the SIG fields may include information about the data unit, for example a description of a length or data rate of the data unit.

Returning to the description of FIG. 3, the transmitter module 300 may further comprise a digital to analog converter 306 configured to convert the output of the transform module into an analog signal. For example, the time-domain output of the transform module 306 may be converted to a baseband OFDM signal by the digital to analog converter 306. In some aspects, portions of the transmitter module 300 may be included in wireless device 202 from FIG. 2. For example, the digital to analog converter 306 may be implemented in the processor 204, the transceiver 214, or in another element of the wireless device 202.

The analog signal may be wirelessly transmitted by the transmitter 310. The analog signal may be further processed before being transmitted by the transmitter 310, for example by being filtered or by being upconverted to an intermediate or carrier frequency. In the aspect illustrated in FIG. 3, the transmitter 310 includes a transmit amplifier 308. Prior to being transmitted, the analog signal may be amplified by the transmit amplifier 308. In some aspects, the amplifier 308 comprises a low noise amplifier (LNA).

The transmitter 310 is configured to transmit one or more packets or data units in a wireless signal based on the analog signal. The data units may be generated using a processor and/or the DSP 320, for example using the modulator 302 and the transform module 304 as discussed above. Data units that may be generated and transmitted as discussed above are described in additional detail below.

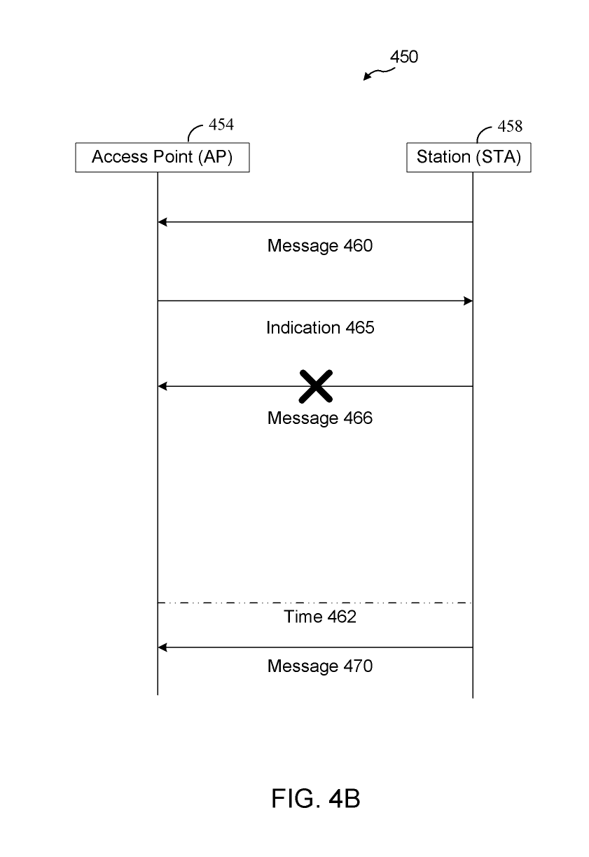

FIG. 4A illustrates a receiving module 400 that may be utilized in the wireless device 202 to receive wireless communications. The components illustrated in FIG. 4A may be used, for example, to receive OFDM communications. In some aspects, the components illustrated in FIG. 4A are used to receive data units that include one or more training fields, as will be discussed in additional detail below. For example, the components illustrated in FIG. 4A may be used to receive data units transmitted by the components discussed above with respect to FIG. 3.

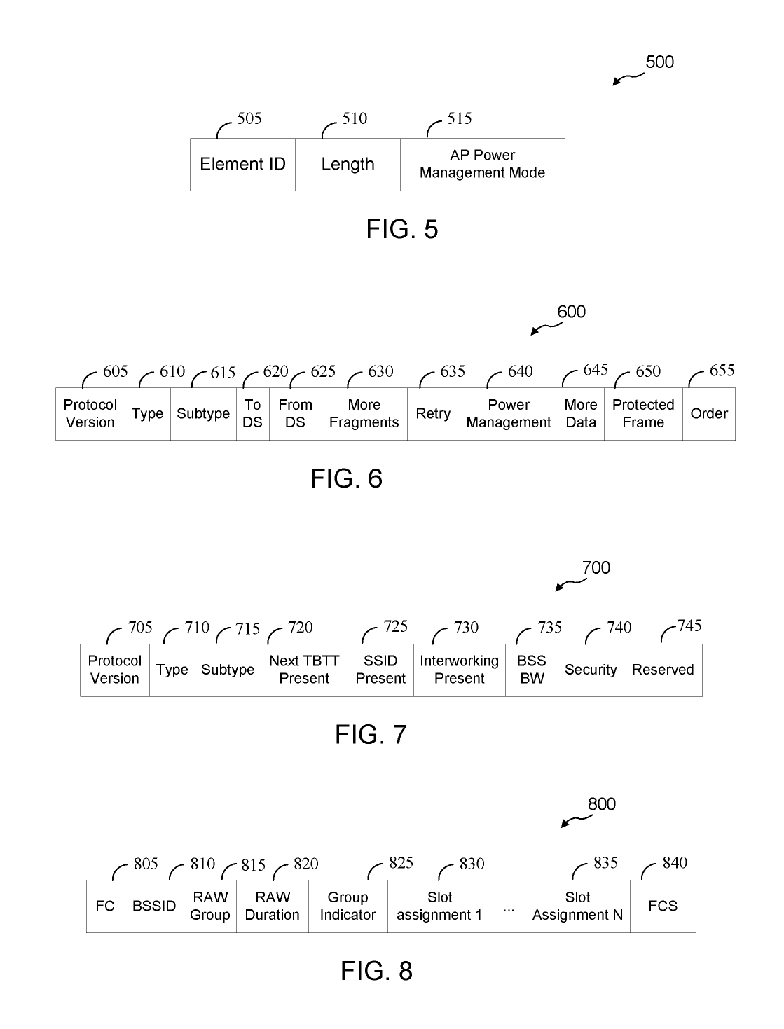

The receiver 412 is configured to receive one or more packets or data units in a wireless signal. Data units that may be received and decoded or otherwise processed as discussed below are described in additional detail with respect to FIGS. 5-7.

In the aspect illustrated in FIG. 4A, the receiver 412 includes a receive amplifier 401. The receive amplifier 401 may be configured to amplify the wireless signal received by the receiver 412. In some aspects, the receiver 412 is configured to adjust the gain of the receive amplifier 401 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 401 comprises an LNA.

The receiving module 400 may comprise an analog to digital converter 402 configured to convert the amplified wireless signal from the receiver 412 into a digital representation thereof. Further to being amplified, the wireless signal may be processed before being converted by the digital to analog converter 402, for example by being filtered or by being downconverted to an intermediate or baseband frequency. In some aspects, analog-to-digital converter 402 may be implemented in the processor 204 of FIG. 2, the transceiver 214, or in another element of the wireless device 202.

The receiving module 400 may further comprise a transform module 404 configured to convert the representation the wireless signal into a frequency spectrum. In FIG. 4A, the transform module 404 is illustrated as being implemented by a fast Fourier transform (FFT) module. In some aspects, the transform module may identify a symbol for each point that it uses.

The receiving module 400 may further comprise a channel estimator and equalizer 405 configured to form an estimate of the channel over which the data unit is received, and to remove certain effects of the channel based on the channel estimate. For example, the channel estimator may be configured to approximate a function of the channel, and the channel equalizer may be configured to apply an inverse of that function to the data in the frequency spectrum.

In some aspects, the channel estimator and equalizer 405 uses information in one or more received training fields, such as a long training field (LTF) for example, to estimate the channel. The channel estimate may be formed based on one or more LTFs received at the beginning of the data unit. This channel estimate may thereafter be used to equalize data symbols that follow the one or more LTFs. After a certain period of time or after a certain number of data symbols, one or more additional LTFs may be received in the data unit. The channel estimate may be updated or a new estimate formed using the additional LTFs. This new or update channel estimate may be used to equalize data symbols that follow the additional LTFs. In some aspects, the new or updated channel estimate is used to re-equalize data symbols preceding the additional LTFs. Those having ordinary skill in the art will understand methods for forming a channel estimate.

The receiving module 400 may further comprise a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. In some aspects, where the receiving module 400 is implemented as a portion of wireless device 202, bits may be processed or evaluated by the processor 204, or used to display or otherwise output information to the user interface 222. In this way, data and/or information may be decoded. In some aspects, the bits correspond to codewords. In one aspect, the demodulator 406 comprises a QAM (quadrature amplitude modulation) demodulator, for example a 16-QAM demodulator or a 64-QAM demodulator. In other aspects, the demodulator 406 comprises a binary phase-shift keying (BPSK) demodulator or a quadrature phase-shift keying (QPSK) demodulator.

### Signaling an AP Doze State

In wireless communications such as those specified in the IEEE 802.11 family of wireless protocols, multiple stations share a transmission medium using a media access control protocol. A beacon frame may be used to establish and maintain the communications over the shared medium in an orderly fashion. In some applications such as those specified in the IEEE 802.11ah protocol, a restricted access window (RAW) may be used to define a period of time that an access point declares as reserved for a selected group of wireless stations. However, the restricted access window does not provide sleep time for the access point.

In some aspects, it may be beneficial to allow an access point to enter a sleep state in order to conserve power. For example, if an AP 104 is a mobile device that runs on a battery, allowing the AP 104 to enter a sleep state at times may reduce power consumption and increase battery life. Thus, it may be beneficial to have a message which defines a time period in which the access point will ignore, fail to consider, or otherwise not accept a packet from any other device, in order to enable power save at the access point. In some aspects, the AP 104 may ignore only certain packets, such as packets from certain devices or certain types of packets. As used herein, the term “ignore” will be employed to describe the absence of action on the part of the AP 104 during the “sleep” or power save time designated by such a message, as opposed to an active refusal to reply or consider an incoming packet, PPDU, or other data message.

In some implementations, an AP 104 may generate a message identifying a time period in which the AP 104 will ignore reception of packets from any wireless station (that is, the AP 104 may enter a sleep or doze state). The AP 104 may then send this message to the wireless stations that the AP 104 is associated with, or a subset of those stations. Upon receipt of the message, wireless stations may refrain from transmitting packets to the AP 104 during the identified time period. In one implementation, the message may be sent to every wireless station associated with the AP 104. These implementations may be applied in processes and standards associated with IEEE 802.11 and/or 802.11 ah among others.

FIG. 4B illustrates an exemplary series of messages and communications between an AP 454 and a STA 458, according to certain aspects of the present disclosure. In the beginning, the AP 454 and the STA 458 may be in communication with one another. The STA 458 may be associated with the AP 454, and may, for example, transmit a message 460 to the AP 454.

At a certain point in time, the AP 454 may determine that it will enter a sleep or a doze state, where it will ignore messages, including those from STA 458. For example, an AP 454 may enter a doze state until time 462. This time may be, for example, a time of a next beacon or other message that the AP 454 may transmit, or the end of another period of time. Accordingly, in order to inform other devices of this doze state, the AP 454 may transmit an indication 465 to the STA 458, indicating that the AP 454 will enter a doze state until time 462. This indication 465 may be broadcasted to all devices, or multicast to a number of devices, or transmitted to the STA 458 specifically.

Having received the indication, the STA 458 may be aware that if it responds with a message 466 prior to time 462, this message 466 will not be received. Accordingly, the STA 458 may be configured not to transmit message 466, since that message 466 will not be received by the AP 454. Accordingly, the STA 458 may be configured not to transmit messaged to the AP 454 until after time 462, based on the indication 465. After time 462 has passed, the STA 458 may transmit a message 470 to the AP 454 as normal. Accordingly, indication 465 may be used to allow the AP 454 to enter a sleep or doze state for a period of time.

In some aspects, the message to wireless stations that the AP 104 is entering a sleep state may comprise an AP power management element. This element may be included in a number of different frames, such as in a Beacon or a Short Beacon frame (which may be known as sub 1 GHz (S1G) Beacon frame). In some aspects, a beacon interval may refer to the interval between beacons. A beacon frame may include either a beacon frame or a short beacon frame (such as a S1G beacon frame), and a beacon interval may include either a beacon interval or a short beacon (SIG beacon) interval. FIG. 5 is an exemplary AP power management element 500 which may be transmitted to wireless stations associated with the access point to indicate that the AP will sleep. For example, the AP power management 500 element may include an Element ID 505, a Length 510 of the time that the AP will be asleep, and an AP power management Mode 515, indicating the power management mode that the AP is entering. Each of these three portions of the element 500 may be one byte (octet) each. Accordingly, the AP power management element 500 may be three bytes in length, as it may be comprised of three one-byte portions or fields. In some aspects, the Element ID 505 may indicate a Group ID, such as a Group ID which identifies a number of wireless devices. These wireless devices may be devices which the AP 104 will ignore the transmissions of, or may be devices for which the sleep mode does not apply. That is, the AP 104 may enter a sleep state where only a subset of the wireless stations associated with the AP 104 may contact it. Element ID 505 may be used, at least in part, to identify this subset of wireless devices. This AP power management element 500 may be transmitted by an AP 104 to one or more STAs 106, and may indicate to the STAs 106 that the AP 104 will sleep for some duration of time, such as a duration indicated to the STA via an element during (re-) association.

One disadvantage with this approach, however, is that such an AP power management element 500 may require three bytes to be transmitted by the AP 104. In some aspects, this three-byte AP power management element 500 may need to be transmitted frequently. For example, in some aspects, an AP 104 may enter a sleep state frequently. Thus, having to send a three-byte AP power management element 500 each time may create a large amount of network overhead. Accordingly, in some aspects, it may be desired to allow the AP 104 to enter a sleep state but to transmit a significantly smaller message upon entering such a sleep state. For example, a one-bit data field in a Beacon frame, a S1G Beacon frame, or another frame could be used to transmit sleep information, rather than using a three-byte AP power management element 500. This may significantly reduce network overhead by limiting the amount of data which must be transmitted on the network in order to allow the AP 104 to enter into a sleep state.

In some aspects, the portion of a frame that is used to convey AP sleep state information to other devices may be a reserved data field, or a data field that has a reserved value for certain types of frames. For example, certain frames may contain a reserved data field. These data fields may be reserved so that they may be used to add future functionality to the frame, and may not be used to convey any information. Accordingly, certain reserved data fields may be used to transmit AP 104 sleep information. For example, a data field that was previously reserved may be re-purposed to transmit AP power management information. Frames may also contain data fields with values that are reserved in certain situations. For example, certain frames may contain data fields which, when the frame is sent by a certain device such as an AP 104, may have a reserved value (but where the value is not reserved in other situations). These data fields, which may not currently be used to convey any information, may be used to convey information regarding an AP 104 entering a sleep state. In some aspects, it may be beneficial to indicate that an AP 104 is entering into a sleep state using an indication contained in a frame control field of a packet. For example, it may be beneficial to include this indication in the frame control field of a packet, because this may not require sending an additional three bytes of information as might be required by AP power management element 500. Instead, the information that the AP 104 is entering a sleep state may be contained in a reserved data field or a currently unused data field in a frame control field of a packet.

FIG. 6 is an illustration of a frame control field 600 of a management frame. This frame control field 600 may contain a number of data fields, including one or more data fields that, when the frame control field 600 is transmitted by an AP 104, may have a reserved value. For example, such a frame control field 600 may be provided for in one or more IEEE 802.11 standards. Such a frame control field 600 includes a two-bit protocol version field 605, a two-bit type field 610, a four-bit subtype field 615, a one-bit to DS field 620, a one-bit from DS field 625, a one-bit more fragments field 630, a one-bit retry field 635, a one-bit power management field 640, a one-bit more data field 645, a one-bit protected frame field 650, and a one-bit order field 655. In some aspects, the bit-lengths of these various data fields may be different from these values. This frame control field 600 format may be provided in one or more IEEE 802.11 standards. Typically, in a management frame sent by an AP, the power management field is set to 0 by convention. Such a data field with a reserved value may be used to transmit information regarding an AP sleep state. Accordingly, in some aspects, it may be beneficial to use this one-bit data field to convey information regarding whether or not the AP will enter a sleep state. For example, if the AP is going to enter a sleep state, then the power management field of the frame control field 600 of a management frame or an extended frame sent by the AP may be set to 1. The extended frame may be a beacon, such as an S1G beacon. This may allow an AP to signal to STAs that the AP will enter a sleep state for some period of time. Because this signal is contained within a previously-existing one-bit data field, no additional data may be required to signal that the AP is entering a sleep state. In some aspects, other reserved or otherwise unused fields may also be used to transmit information regarding whether the AP is entering a sleep state, and information regarding how long this state may last, and which devices, if any, may contact the AP during this state.

Similarly, reserved fields may also be used to convey information regarding whether the AP 104 will enter into a sleep state. FIG. 7 illustrates the frame control field 700 of a S1G Beacon frame which may be modified to signal whether an AP 104 will enter a sleep state. This frame control field 700 includes a two-bit protocol version field 705, a two-bit type field 710, a four-bit subtype field 715, a one-bit next TBTT present field 20, a one-bit compressed SSID present field 725, a one-bit interworking present field 730, a three-bit basic service set (BSS) bandwidth (BW) field 735, a one-bit security field 740, and a one-bit reserved field 745. In some aspects, the bit-lengths of these various fields may be different from these values. This frame control field 700 may be used by wireless devices which act in accordance with one or more IEEE 802.11 standards. In some aspects, the one-bit reserved field 745, which may be currently not used in the frame control field 700, may be used to transmit information regarding whether the AP will enter a sleep state. For example, the reserved field 745 may be set to 1 in order to signal that the AP 104 will enter a sleep state for at least some period of time. In some aspects, reserved field 745 may thereby be used as a one-bit power management field. For example, this filed may indicate whether the AP 104 may go to sleep mode until the time of a future beacon frame. In certain aspects the reserved field may be renamed as access point power management (AP PM) field.

The frame control field 700 which contains an indication that an AP 104 will go to sleep may be contained in a number of types of frames sent by the AP 104. For example, FIG. 8 illustrates a resource allocation frame 800 which may be modified to signal whether an AP will enter a sleep state. The resource allocation frame 800 includes a two-octet frame control (FC) field 805, a six-octet basic service set (BSS) ID field 810, a 3-octet resource allocation window (RAW) Group field 815, a two-octet RAW duration field 820, a one-octet group indicator field 825, a number of slot assignment fields, from slot assignment 1 field 830 to slot assignment N field 835 each three or four octets, and finally a four-octet FCS field 840. In this frame, the FC field 805 may indicate to the STAs which receive the frame that the AP is going to be asleep for a time duration which is indicated in the resource allocation frame 800. For example, as before, this indication to the STAs may be based upon a one-bit data field in the FC field 805. In some aspects, the time that the AP is going to be asleep may be inferred by the resource allocation frame 800. For example, the AP may be asleep for the duration of time indicated in the RAW duration field 820. In some aspects, the AP may be asleep for the duration of time indicated in the one or more of the slot assignment fields. For example, the wireless network may be configured such that the AP will sleep for each of the slot assignment fields from 1 to N−1, when a power management bit in the FC field 805 is set to 1. Accordingly, such a configuration may allow the AP to indicate to the STAs in the network when the AP will sleep, based upon fields contained in already-existing frames, rather than having to send an additional three-byte frame to indicate such information to the STAs.

In some aspects, the above concepts of signaling may be used together with the AP power management element 500. For example, signaling based upon a one-bit power management field 640 or the reserved field 745, eventually renamed as AP PM field, may indicate to receiving STAs the presence of an AP power management element 500. In some aspects, the AP power management element 500 may be used to signal a number of different things to the STAs 106. For example, the AP power management element 500 may include a duration of time for the power saving mode. In some aspects the element that indicates the duration of time for power saving mode is the max away duration (MAD) element which may be additionally included in probe response and (re-)association response frames.

In some aspects, the AP 104 indicates that it may be asleep for a certain interval of time, such as the (short) beacon interval that follows the beacon, by setting the AP PM field in the frame control field of the SIG beacon frame to 1. The interval of time that the AP can go to sleep may not exceed the duration of time that is indicated in the most recently transmitted element to the associated STA 106 (for example the MAD element). This allows STAs 106 to know the amount of times the AP 104 plans to sleep during association so that if the duration is not acceptable these STAs 106 may decide not to associate because of quality of service requirements. However, unless the AP 104 explicitly signals the interval of time during which it plans to be asleep during the beacon interval by including an RPS element to signal this interval (e.g., including an omni-RAW for AP PM), the STA 106 may not know when the AP 104 may go to sleep during the beacon interval. This may require the STA 106 to continuously poll the AP 104 during the beacon interval to eventually get a response when the AP 104 is awake. This behavior can potentially increase the number of polls generated in the network, decrease network efficiency and increase power consumption for the STAs 106 as they need to generate redundant polling messages.

Hence, an AP 104 that does not signal an AP PM RAW in the beacon frame that precedes the (short) beacon interval, should guarantee to its associated STAs 106 that it shall be awake in a pre-defined portion of the (short) beacon interval. In some aspects, this pre-defined portion of the (short) beacon interval can immediately follow the transmission of the frame (e.g., the S1G beacon) that signals the AP PM mode. In some other aspects, any other deterministic function can be used to identify the start time of the pre-defined portion of the (short) beacon interval that the AP guarantees not to be in AP PM mode (sleep). In some aspects, this pre-defined portion of time shall not be less than the duration of the (short) beacon interval minus the max away duration value that the AP has signaled to its associated STAs. This way, STAs know that the AP that sets AP PM to 1 in the S1G beacon frame, shall be awake immediately after the frame for the duration derived from the (short) beacon interval and the max away duration, both quantities known by the STAs.

In some aspects, the AP 104 may be asleep with respect to some STAs 106, but awake with respect to other STAs 106. This may be indicated in the AP power management element 500. For example, the AP power management element 500 may also include a group ID, such as in the element ID field 505. This group ID may identify one or more wireless devices specifically, such as identifying a class of wireless devices within the wireless network. These identified devices may correspond to devices which the AP 104 will be able to receive packets from, even during the sleep state. Alternatively, these identified devices may also correspond to a group ID for devices which will not be able to transmit to the AP 104 during the sleep state. For example, the element ID 505 field of the AP power management element 500 may be used to indicate a subset of receiving STAs 106 which may consider the AP 104 in a sleep mode for the specified duration. For example, such an element may include a selective indication of power save more for relay devices.

Generally, the concepts discussed above, while referencing the AP 104, may be used by any device, and not merely the AP 104. For example, the concepts may be used by any devices which might generate management frames, including beacons, S1G beacons, action frames, and resource allocation frames. For example, an action frame may be a frame which is meant for sending information elements to other stations, such as in situations where sending the information in a beacon is not possible.

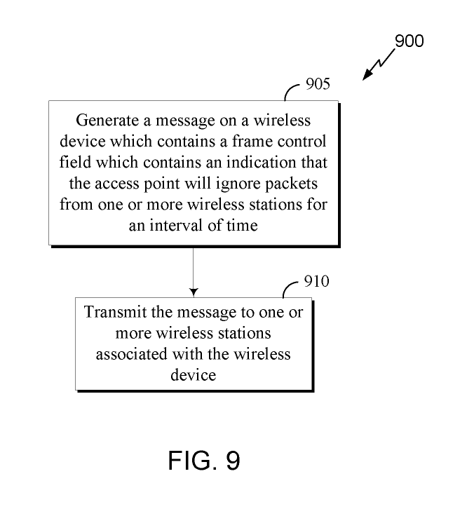

FIG. 9 is a flowchart of a method 900 of wireless communication in accordance with one implementation. The method 900 may be performed by an apparatus for wireless communication, such as the access point (AP) 104 (shown in FIG. 1). At block 905, the method includes generating a message which contains a frame control field containing an indication that the access point will ignore reception of packets from one or more wireless stations for an interval of time. For example, this field may be the power management field 640 of FIG. 6, the reserved field 745 of FIG. 7, or another field with a reserved or otherwise unused value in any type of message. In one aspect, the message may further indicate the period of time that the wireless device will ignore messages, or this period of time may be inferred based on other information, or this period of time may be predefined, such as up until a next access window or beacon. In one aspect, the message signals the presence of another element, containing more information on the sleep mode of the transmitting device. For example, the message may signal the presence of an element such as element 500 in FIG. 5. The means for generating this message may include a processor. At block 910, the method includes transmitting the message to one or more wireless stations associated with the wireless device. In some aspects, the message may indicate that the wireless device may ignore reception of packets from a subset of the wireless stations associated with the wireless device. This subset may be predefined, or may be determined based upon other parts of the message or based upon other parts of other messages transmitted in the wireless network. The means for transmitting the message may include a transmitter.

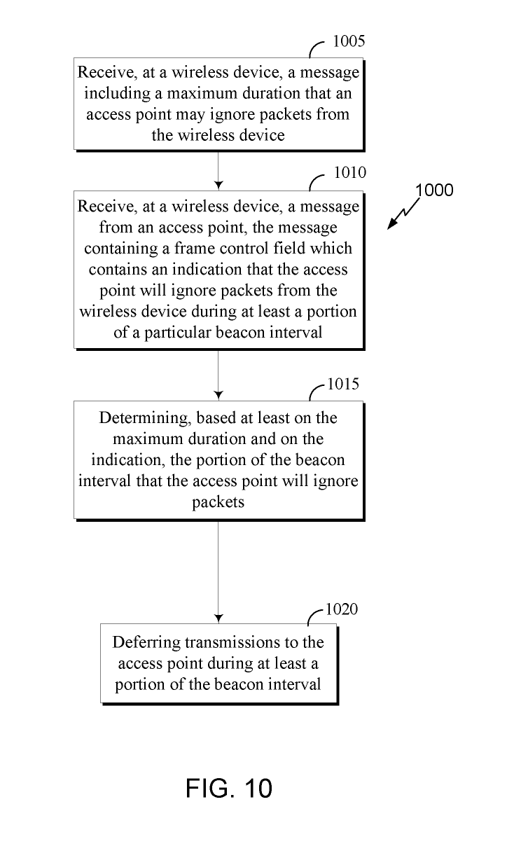

FIG. 10 is a flowchart of a method 1000 of wireless communication in accordance with one implementation. The method 1000 may be performed by an apparatus for wireless communication, such as a STA 106.

At block 1005, the STA 106 receives a message including a maximum duration than an access point will ignore reception of packets from the wireless device. For example, these messages may be contained in a max away duration (MAD) element which may be included in probe response and (re-)association response frames. This maximum duration may indicate a maximum period of time that the AP may sleep for. In some aspects, the STA 106 may receive these messages at association, or may receive these messages at other times. In some aspects, the means for receiving may include a receiver.

At block 1010, the STA 106 receives a message from an access point, the message containing a frame control field which contains an indication that the access point will ignore reception of packets from the wireless device during at least a portion of a particular beacon interval. For example, this indication may be a one-bit data field, such as the AP PM field described above. This one-bit data field may indicate that the AP intends to enter a sleep mode for at least a portion of the beacon interval. For example, the message may be a beacon or a short beacon (S1G beacon), and the indication may indicate that the AP intends to enter a sleep more for at least a portion of the interval until the next beacon (S1G beacon or other beacon). In some aspects, the means for receiving may include a receiver.

At block 1015, the STA 106 determines, based at least on the maximum duration and on the indication, the portion of the beacon interval that the access point will ignore reception of packets. For example, the STA 106 may determine that the AP 104 will ignore reception of packets for a time that does not exceed the max away duration during the beacon interval. If this duration is greater than the beacon interval, the AP 104 may ignore reception of packets for the entire interval. If this duration is less than the beacon interval, the AP 104 may ignore reception of packets during only a portion of the beacon interval and may receive packets at other portions of the beacon interval. For example, the AP 104 may be configured to sleep during the last portion of the beacon interval, and may be configured to receive packets during a first portion of the beacon interval. Accordingly, the STA 106 may transmit packets to the AP 104 during the first portion of the beacon interval, as it knows that the AP 104 may sleep for the last portion of the beacon interval. In some aspects the first portion of the beacon interval has a duration that is not less than the duration of the (short) beacon interval minus the value of the max away duration. In some aspects, the means for determining may include a processor.

At block 1020, the STA 106 defers transmissions to the access point during at least a portion of the beacon interval. For example, the STA 106 may wish to transmit to the AP 104 during the beacon interval. However, because of the indication in the message, the STA 106 may be aware that the AP 104 will sleep during a portion of the beacon interval. For example, the STA 106 may know that the AP 104 may sleep during all of the beacon interval, or during a particular portion of the beacon interval (such as the last portion). Accordingly, the STA 106 may choose not to transmit to the AP 104 during these times, and may instead defer those translations to a later time when the AP 104 may be awake. In some aspects, the STA 106 may transmit to the AP 104 during another portion of the beacon interval, where the STA 106 knows the AP 104 will be awake. For example, if the STA 106 knows that the AP 104 will be awake during a first portion of the beacon interval, it may transmit to the AP 104 during the first portion of the beacon interval. In some aspects the first portion of the beacon interval has a duration that is not less than the duration of the value of the (short) beacon interval minus the value of the max away duration. In some aspects, the means for deferring may include a processor.

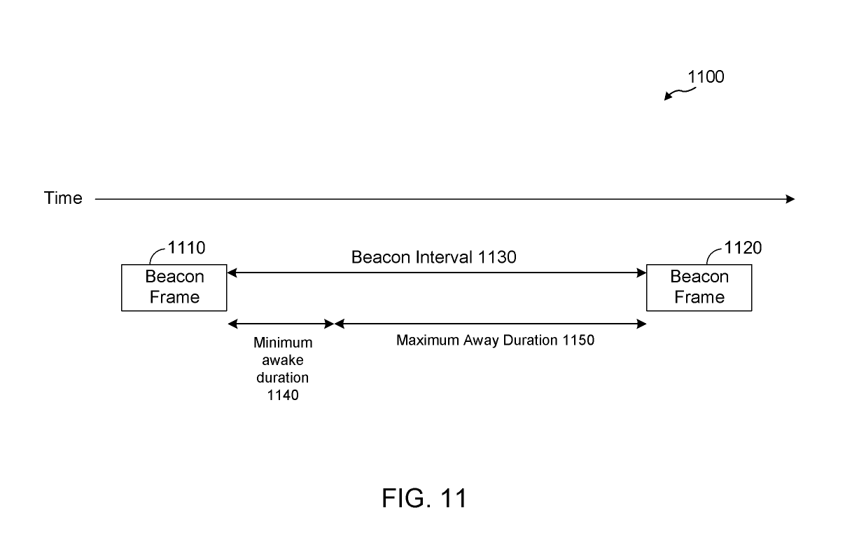

FIG. 11 is an illustration 1100 of the timing of a maximum away duration in a beacon interval. In this illustration 1100, a beacon frame 1110 is transmitted by an access point. This beacon frame 1110 may be a short beacon frame, such as an S1G beacon frame. This beacon frame 1110 may include an indication that the access point will sleep (that is, ignore reception of packets from other wireless devices) for a portion of the beacon interval 1130 which follows the beacon frame 1110 and which precedes the next beacon frame 1120. In some aspects, if a short beacon frame, such as a S1G beacon frame, is transmitted, the beacon interval 1130 may instead be referred to as a short beacon interval, as it may be a time between two short beacon frames rather than between two beacon frames.

The indication in the beacon frame 1110 may take a number of forms. For example, one form of the indication may be a maximum away duration 1150. This duration may be included in the beacon frame 1110 as a measure of time, or a proportion of the beacon interval 1130, or in another form. For example, if a beacon interval was 5 seconds, the maximum away duration 1150 may be 3 seconds. This maximum away duration may indicate a maximum amount of time that the access point will sleep during the beacon interval 1130. As illustrated, the maximum away duration 1150 may occur at a last portion of the beacon interval 1130. That is, the access point may be awake (able to receive packets from other devices) during the portion of the beacon interval 1130 which immediately follows the beacon frame 1110, and may then sleep during the last portion of the beacon interval.

Based upon the length of the beacon interval 1130 and the length of the maximum away duration 1150, a device may infer a minimum awake duration 1140. This may be the minimum amount of time during the beacon interval 1130 that the access point will be awake (able to receive packets) for. For example, the access point may indicate that it may sleep for a maximum of 3 seconds of a 5 second interval. Accordingly, a device may infer that the access point will be awake for a minimum of 2 seconds. As illustrated in FIG. 11, this minimum awake duration 1140 may immediately follow the beacon frame 1110. Accordingly, a device that wishes to transmit to the access point may be configured to attempt transmissions to the access point during this minimum awake duration 1140 time, and may not attempt transmissions during the maximum away duration 1150. In some aspects, the awake duration may occur at other times in the beacon interval 1130 as well. For example, the minimum awake duration 1140 may occur at the end of the beacon interval 1130. At the end of the beacon interval 1130, the access point may transmit another beacon frame 1120. After this beacon frame 1120, there may be another beacon interval, during which the access point may again sleep for some, all, or none of the interval, based upon an indication in the beacon frame 1120.

In some of the foregoing implementations, a message from an access point specifies a restricted access window, a period of time that the access point declares as reserved for a selected group of wireless stations, such as one specified in the 802.11ah protocol. Alternatively, the message may specify an access window during which access to the medium is granted to all wireless stations. In other words, the access point will accept a packet from all wireless stations during the access window.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An access point in a wireless communication network comprising:
a processor configured to generate a message, the message containing a frame control field which contains an indication that the access point will ignore reception of packets from one or more wireless stations for a period of time; and
a transmitter connected to the processor and configured to transmit the message to one or more wireless stations associated with the access point.

2. The access point of claim 1, wherein the indication comprises a one-bit data field.

3. The access point of claim 2, wherein the indication comprises at least one of a reserved data field, a data field with a reserved value, and an access point (AP) power management (PM) data field.

4. The access point of claim 1, wherein the indication further indicates the presence of an access point power management element.

5. The access point of claim 1, wherein the message comprises a management frame.

6. The access point of claim 5, wherein the management frame comprises one of a beacon frame, a short beacon frame, an action frame, or a resource allocation frame.

7. The access point of claim 1, wherein the message comprises an S1G beacon frame.

8. The access point of claim 1, wherein the message further includes an indication of an amount of time that the access point will ignore reception of packets from the one or more wireless stations.

9. The access point of claim 1, wherein the message further contains an indication that the wireless device will ignore reception of packets from one or more wireless stations which are a subset of the one or more wireless stations associated with the access point.

10. The access point of claim 1, wherein the message further contains an indication that the access point will be awake for a particular portion of a beacon interval or a short beacon interval.

11. The access point of claim 10, wherein the particular portion of the beacon interval or the short beacon interval immediately follows a transmission of the message.

12. The access point of claim 10, wherein the particular portion of the beacon interval or the short beacon interval is pre-defined or is based on a deterministic function.

13. The access point of claim 1, wherein the transmitter is further configured to transmit a second message which indicates a maximum duration that the access point will ignore reception of packets from the one or more wireless stations.

14. A method of wireless communication, comprising:
generating a message, by an access point, containing a frame control field which contains an indication that the access point will ignore reception of packets from one or more wireless stations for a period of time; and
transmitting the message to one or more wireless stations associated with the access point.

15. The method of claim 14, wherein the indication comprises a one-bit data field.

16. The method of claim 15, wherein the indication comprises at least one of a reserved data field, a data field with a reserved value, and an access point power management data field.

17. The method of claim 14, wherein the indication further indicates the presence of an access point power management element.

18. The method of claim 14, wherein the message comprises a management frame.

19. The method of claim 18, wherein the management frame comprises one of a beacon frame, a short beacon frame, an action frame, or a resource allocation frame.

20. The method of claim 14, wherein the message comprises an S1G beacon frame.

21. The method of claim 14, wherein the message further includes an indication of the amount of time that the access point will ignore reception of packets from the one or more wireless stations.

22. The method of claim 14, wherein the message signals that the access point will ignore reception of packets from one or more wireless stations which are a subset of the one or more wireless stations associated with the access point.

23. The method of claim 14, wherein the message further contains an indication that the access point will be awake for a particular portion of a beacon interval or a short beacon interval.

24. The method of claim 23, wherein the particular portion of the beacon interval or the short beacon interval immediately follows a transmission of the message.

25. The method of claim 23, wherein the particular portion of the beacon interval or the short beacon interval is pre-defined or is based on a deterministic function.

26. The method of claim 14, further comprising transmitting a second message which indicates a maximum duration that the access point may ignore reception of packets from the one or more wireless stations.

27. An access point on a wireless network comprising:
means for generating a message, by the access point, containing a frame control field which contains an indication that the access point will ignore reception of packets from one or more wireless stations for a period of time; and
means for transmitting the message to one or more wireless stations associated with the access point.

28. A non-transitory computer readable storage medium comprising computer executable instructions configured to implement a method for wireless communication, the method comprising:
generating a message, by an access point, containing a frame control field which contains an indication that the access point will ignore reception of packets from one or more wireless stations for a period of time; and
transmitting the message to the one or more wireless stations associated with the access point.

29. A method for wireless communication, the method comprising:
receiving, at a wireless device, a message from an access point, the message containing a frame control field which contains an indication that the access point will ignore reception of packets from the wireless device during at least a portion of a beacon interval; and
deferring transmissions to the access point during at least the portion of the beacon interval.

30. The method of claim 29, further comprising:
receiving, at the wireless device, a second message including a maximum duration that the access point may ignore reception of packets from the wireless device; and
determining, based at least on the maximum duration and on the indication, the portion of the beacon interval that the access point will ignore reception of packets.

31. The method of claim 29, wherein the portion of the beacon interval that the access point will ignore reception of packets is a last portion of the beacon interval.

32. The method of claim 31, further comprising transmitting a packet to the access point during a first portion of the beacon interval prior to the last portion of the beacon interval.

33. The method of claim 29, wherein the indication comprises a one-bit data field.

34. The method of claim 29, wherein the message comprises a management frame.

35. The method of claim 34, wherein the management frame comprises one of a beacon frame, a short beacon frame, an action frame, or a resource allocation frame.

36. The method of claim 29, wherein the message comprises an S1G beacon frame.

37. A wireless device for wireless communication, the wireless device comprising:
a receiver configured to receive a message from an access point, the message containing a frame control field which contains an indication that the access point will ignore reception of packets from the wireless device during at least a portion of a beacon interval; and
a processor configured to defer transmissions to the access point during at least the portion of the beacon interval.

38. The wireless device of claim 37, the receiver further configured to receive a second message including a maximum duration that the access point will ignore reception of packets from the wireless device, and the processor further configured to determine, based at least on the maximum duration and on the indication, the portion of the beacon interval that the access point will ignore reception of packets.

39. The wireless device of claim 37, wherein the portion of the beacon interval that the access point will ignore reception of packets is a last portion of the beacon interval.

40. The wireless device of claim 39, further comprising a transmitter configured to transmit a packet to the access point during a first portion of the beacon interval prior to the last portion of the beacon interval.

41. The wireless device of claim 37, wherein the indication comprises a one-bit data field.

42. The wireless device of claim 37, wherein the message comprises a management frame.

43. The wireless device of claim 42, wherein the management frame comprises one of a beacon frame, a short beacon frame, an action frame, or a resource allocation frame.

44. The wireless device of claim 37, wherein the message comprises an S1G beacon frame.

45. A wireless device for wireless communication, the device comprising:
means for receiving, at the wireless device, a message from an access point, the message containing a frame control field which contains an indication that the access point will ignore reception of packets from the wireless device during at least a portion of a beacon interval; and
means for deferring transmissions to the access point during at least a portion of the beacon interval.

46. A non-transitory computer readable storage medium comprising computer executable instructions configured to implement a method for wireless communication, the method comprising:
receiving, at a wireless device, a message from an access point, the message containing a frame control field which contains an indication that the access point will ignore reception of packets from the wireless device during at least a portion of a beacon interval; and
deferring transmissions to the access point during at least a portion of the beacon interval.
